(19) United States
(12) Patent Application Publication
(10) Pub. No.: US 2008/0225004 A1
(43) Pub. Date: Sep. 18, 2008

(54) WIRELESS MOUSE

(75) Inventors: MING-CHIH HSIEH, Tu-Cheng (TW); TSUNG-HSI LI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/833,241

(22) Filed: Aug. 3, 2007

(30) Foreign Application Priority Data
Mar. 16, 2007 (CN) 200710200298.0

(51) Int. Cl. G06F 3/033

(52) U.S. Cl. 345/163

(57) ABSTRACT

A wireless mouse includes a main body, a cover disposed above the main body, a circuit board mounted in the main body, a power switch disposed on the circuit board configured for controlling power supply from a power source to the circuit board, and a trigger mounted on the cover and movable relative to the cover. When a user depresses the cover, the trigger actuates the power switch to allow the power source providing power to the wireless mouse; when the user releases the cover, the trigger releases the power switch to interrupt power to the wireless mouse.

### BACKGROUND

1. Field of the Invention

The present invention relates to wireless mouses. In particular, the present invention relates to a wireless mouse with a power saving function.

2. Description of Related Art

A wireless mouse communicates with a computer system by means of electromagnetic signals. Since no cable connects the mouse to the computer system, the mouse has to incorporate an independent power source therein. Thus, power management becomes an important issue in the field of wireless mouses.

A conventional power saving method incorporates a sleeping mode when the mouse is inactive. However, the wireless mouse still consumes power in the sleeping mode. Another conventional power saving method is using a power switch arranged at a bottom of the wireless mouse to solve the above-mentioned problem. Power provided to the wireless mouse is switched off by the power switch to save power when the wireless mouse is not in use. However, users often forgot to shut down the mouse. Moreover, it is unduly inconvenient to operate the power switch.

What is needed is a wireless mouse for facilitating power management thereof.

### SUMMARY

An exemplary wireless mouse includes a main body, a cover disposed above the main body, a circuit board mounted in the main body, a power switch disposed on the circuit board configured for controlling power supply from a power source to the circuit board, and a trigger mounted on the cover and movable relative to the cover. When a user depresses the cover, the trigger actuates the power switch to allow the power source providing power to the wireless mouse; when the user releases the cover, the trigger releases the power switch to interrupt power to the wireless mouse.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an exploded, isometric view of a wireless mouse according to an embodiment of the present invention, the wireless mouse device including a trigger, and a main body;

FIG. 2 is a partially assembled view of the trigger and the main body of FIG. 1; and

FIG. 3 is an assembled view of the wireless mouse of FIG. 1.

### DETAILED DESCRIPTION

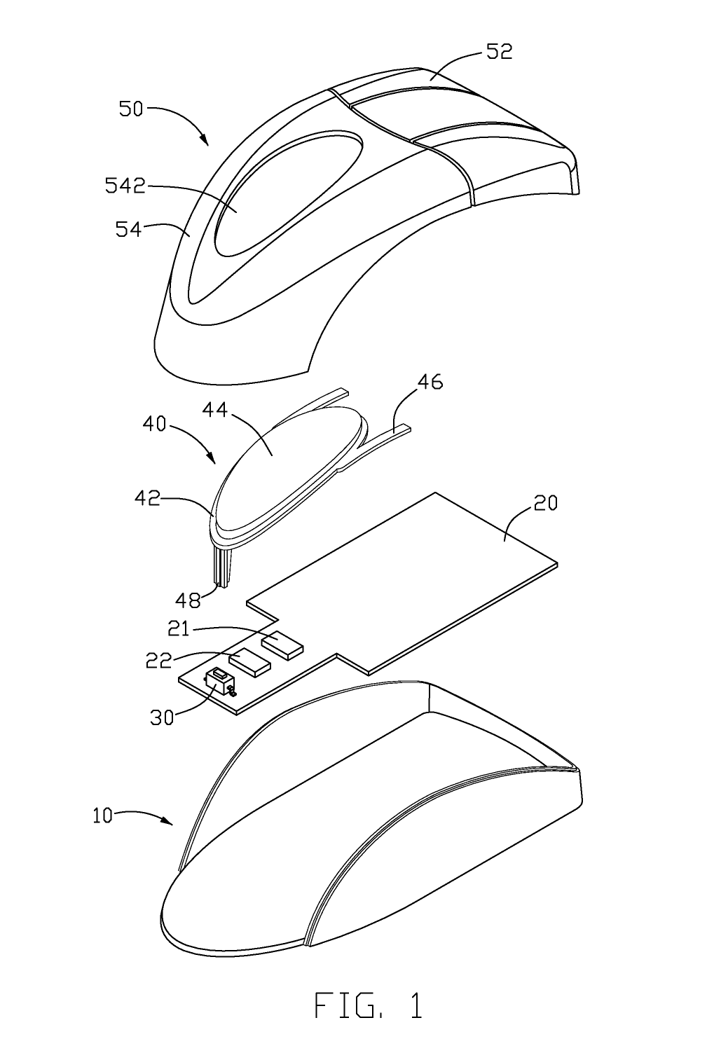

Referring to FIG. 1, a wireless mouse according to an embodiment of the present invention includes a main body 10, a circuit board 20, a power switch 30, a trigger 40, and a cover 50.

The power switch 30 is disposed on the circuit board 20. An infrared transmitter 21 and a battery 22 are placed on the circuit board 20. The battery 22 is used for providing power to the infrared transmitter 21. The power switch 30 is used to turn on or off power from the battery 22 to the infrared transmitter 21.

A front part of the cover 50 is used as a finger operating portion 52. A rear part of the cover 50 has a raised palm rest portion 54. The palm rest portion 54 defines a through hole 542 in the center thereof.

The trigger 40 includes an annular stopper portion 42, an arcuate protrusion 44 extending upwardly from inner edges of the annular stopper portion 42, an elastic portion such as a pair of elastic arms 46 extending forwardly from a higher end of the annular stopper portion 42, and a contact portion such as a protruding post 48 extending downwardly at a lower end of the annular stopper portion 42. The arcuate protrusion 44 of the trigger 40 has a curved surface configured as a palm rest.

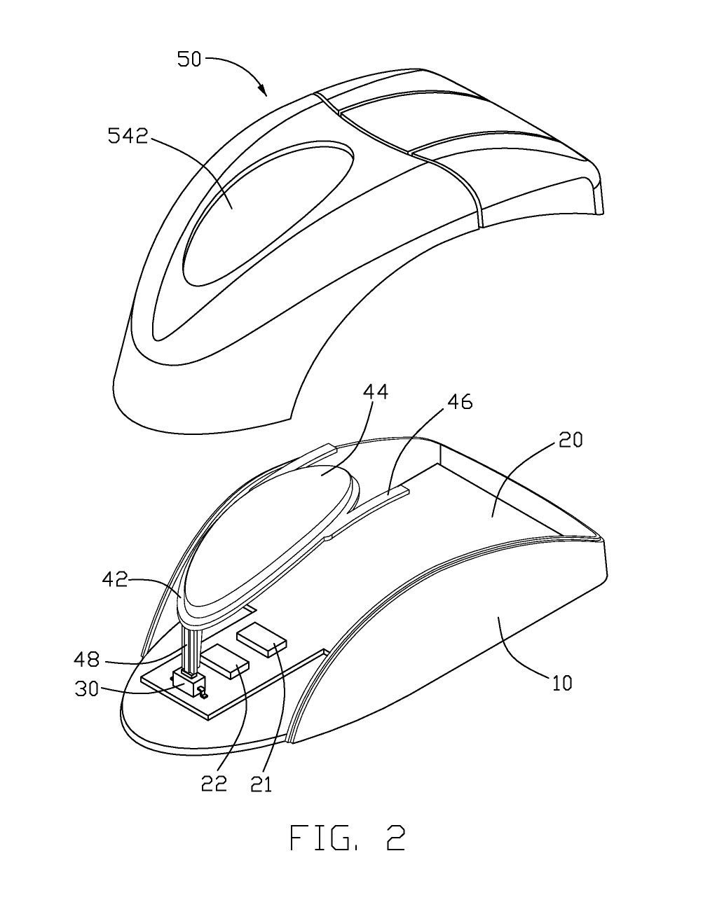

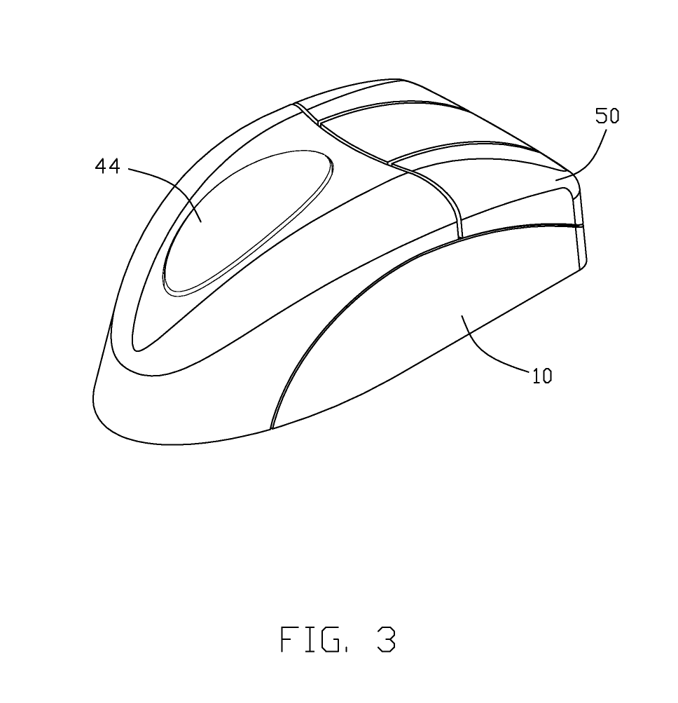

Referring also to FIG. 2 and FIG. 3, the circuit board 20 is mounted in an inner space of the main body 10. The elastic arms 46 of the trigger 40 are mounted in an inner side of the cover 50. In this embodiment, distal ends of the elastic arms 46 are affixed to the inner side of the cover 50. The arcuate protrusion 44 of the trigger 40 extends out from the through hole 542 of the palm rest portion 54. The stopper portion 42 is blocked by the inner side of the cover 50 to prevent the arcuate protrusion 44 escaping from the through hole 542. When the main body 10 is covered by the cover 50, a distal end of the protruding post 48 of the trigger 40 contacts the power switch 30.

When the wireless mouse is in use, e.g. when a user's palm is placed on the wireless mouse, the arcuate protrusion 44 of the trigger 40 is depressed by the palm. Thus, the protruding post 48 of the trigger 40 is depressed to actuate the power switch 30. Consequently, the power from the battery 22 is provided to the infrared transmitter 21 so that the wireless mouse is in an operation mode. At this time, the elastic arms 46 are in an elastically deformed state.

When the wireless mouse is not in use, e.g. when the user's palm leaves the wireless mouse, the arcuate protrusion 44 of the trigger 40 returns to its original position by rebound of the elastic arms 46. Thus, the protruding post 48 of the trigger 40 releases the power switch 30. Consequently, power to the infrared transmitter 21 from the battery 22 is interrupted so that the wireless mouse shuts off. When the arcuate protrusion 44 rebounds, it is blocked from going too far by the cover 50 because of the stopper portion 42.

The wireless mouse in accordance with the embodiment of the present invention can turn on the power provided to the wireless mouse when the user puts his palm thereon, and turn off the power provided to the wireless mouse when the user take off his palm. It is convenient for the user to control power to the wireless mouse, and can save power when the wireless mouse is not in use.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless mouse comprising:
a main body;
a cover disposed above the main body;
a circuit board mounted in the main body;
a power switch disposed on the circuit board configured for controlling power supply from a power source to the circuit board; and
a trigger mounted on the cover and being movable relative to the cover;
when a user depresses the cover, the trigger actuates the power switch to allow the power source providing power to the wireless mouse; when the user releases the cover, the trigger releases the power switch to interrupt power to the wireless mouse.

2. The wireless mouse as described in claim 1, wherein the trigger comprises a protrusion, an elastic portion mounted on the cover, and a contact portion, the cover defines a through hole for the protrusion of the trigger extending out, when the protrusion of the trigger is depressed the power switch is actuated by the contact portion of the trigger.

3. The wireless mouse as described in claim 2, wherein the cover comprises a finger operating portion and a palm rest portion, the through hole of the cover is defined at the central area of the palm rest portion.

4. The wireless mouse as described in claim 2, wherein the protrusion of the trigger has a curved surface configured as a palm rest.

5. The wireless mouse as described in claim 2, wherein the trigger further comprises an annular stopper portion, the protrusion of the trigger extends upwardly from inner edges of the annular stopper portion, the annular stopper portion is blocked by the inner side of the cover.

6. The wireless mouse as described in claim 5, wherein the contact portion of the trigger is a protruding post extending downwardly at a lower end of the annular stopper portion.

7. The wireless mouse as described in claim 5, wherein the elastic portion is a pair of elastic arms extending forwardly from a higher end of the annular stopper portion.

8. A wireless mouse comprising:
a main body and a cover fastened to each other to accommodate a circuit board therein;
a power switch disposed on the circuit board for controlling power from a battery to the wireless mouse; and
a trigger movably mounted on the cover;
when a user depresses the cover, the trigger actuates the power switch to provide power to the wireless mouse; when the user releases the cover, the trigger releases the power switch to interrupt power to the wireless mouse.

9. The wireless mouse as described in claim 8, wherein the trigger comprises a protrusion, an elastic portion mounted on the cover, and a contact portion, the cover defines a through hole for the protrusion of the trigger extending out, when the protrusion of the trigger is depressed the power switch is actuated by the contact portion of the trigger.

10. The wireless mouse as described in claim 9, wherein when the user depresses the cover, the contact portion is depressed to actuate the power switch, and the elastic portion is in an elastically deformed state; when the user releases the cover, the contact portion rebounds from the resilience of the elastic portion to release the power switch.

11. A wireless mouse comprising:
a main body and a cover fastened to each other to accommodate a circuit board therein, a through hole being defined in the cover;
a power switch disposed on the circuit board for controlling power from a power source to the wireless mouse; and
a trigger movably attached to the cover and extending out of the through hole, the trigger capable of being depressed to actuate the power switch to allow the power source providing power to the wireless mouse; and
an elastic structure configred for returning the trigger back such that the trigger releases the power switch to interrupt power to the wireless mouse.

12. The wireless mouse as described in claim 11, wherein the cover comprises a finger operating portion and a palm rest portion, the through hole of the cover is defined at the palm rest portion.

13. The wireless mouse as described in claim 11, wherein the trigger comprises a protrusion extending through the through hole of the cover, and a contact portion extending from one end of the protrusion for pressing and actuating the power switch when the trigger being depressed.

14. The wireless mouse as described in claim 13, wherein the elastic structure comprises elastic arms extending from an opposite end of the protrusion, distal ends of the elastic arms being fastened to the cover.

15. The wireless mouse as described in claim 13, wherein the protrusion of the trigger has a curved outer surface exposed via the through hole and configured as a palm rest.

16. The wireless mouse as described in claim 13, wherein the trigger further comprises an annular stopper portion around the protrusion, the annular stopper portion is blocked by an inner surface of the cover when the trigger is returned.
